(19) United States
(12) Patent Application Publication
(10) Pub. No.: US 2020/0409575 A1
(43) Pub. Date: Dec. 31, 2020

(54) STORAGE CONTROL APPARATUS AND NON-TRANSITORY COMPUTER-READABLE STORAGE MEDIUM FOR STORING STORAGE CONTROL PROGRAM

(71) Applicant: FUJITSU LIMITED, Kawasaki-shi (JP)

(72) Inventors: Naoto Kodama, Kawasaki (JP); Yuuki Yamamoto, Kawasaki (JP); Tadashi Kaneko, Kawasaki (JP)

(73) Assignee: FUJITSU LIMITED, Kawasaki-shi (JP)

(21) Appl. No.: 16/910,133

(22) Filed: Jun. 24, 2020

(30) Foreign Application Priority Data
Jun. 27, 2019 (JP) 2019-120092

(51) Int. Cl. G06F 3/06

(52) U.S. Cl. CPC G06F 3/0629; G06F 3/0662; G06F 3/0683; G06F 3/064; G06F 3/0619; G06F 3/0646

(57) ABSTRACT

A storage control apparatus configured to be coupled to a redundant configuration including a first and second storage devices, the storage control apparatus includes: a memory; and processing circuitry coupled to the memory, the processing circuitry being configured to execute a first processing that includes dealing with access to any of the first and second storage devices from a higher-level apparatus; and execute a second processing that includes converting an access destination of the access such that each same physical position in the first and second storage devices corresponds to a first logical address for a first storage device and a second logical address for the second storage device, the first logical address being a logical address different from the second logical address.

### CROSS-REFERENCE TO RELATED APPLICATION

This application is based upon and claims the benefit of priority of the prior Japanese Patent Application No. 2019-120092, filed on Jun. 27, 2019, the entire contents of which are incorporated herein by reference.

### FIELD

The present invention is related to a storage control apparatus and a non-transitory computer-readable storage medium storing a storage control program.

### BACKGROUND

In recent years, due to the increasing demands for the reliability of data storage devices, storage systems capable of mirroring or the like in consideration of failure tolerance have become common.

In mirroring, response performance in access to a disk device is a priority in some cases. For this reason, for access to the same data in a disk device #0 and a disk device #1 included in a storage system, for example, the same logical address is sometimes allocated.

Related techniques are disclosed in, for example, Japanese Laid-open Patent Publication Nos. 2000-293946 and 2000-66961.

### SUMMARY

According to an aspect of the embodiments, a storage control apparatus configured to be coupled to a redundant configuration including a first and second storage devices, the storage control apparatus includes: a memory; and processing circuitry coupled to the memory, the processing circuitry being configured to execute a first processing that includes dealing with access to any of the first and second storage devices from a higher-level apparatus; and execute a second processing that includes converting an access destination of the access such that each same physical position in the first and second storage devices corresponds to a first logical address for a first storage device and a second logical address for the second storage device, the first logical address being a logical address different from the second logical address.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram schematically illustrating a configuration example of a storage system in an example of an embodiment.

FIG. 2 is a diagram exemplifying the positional relationship between heads and disks in each of the disk devices illustrated in FIG. 1.

FIG. 3 is a diagram exemplifying the allocation of logical addresses in each platter of the disk device #0 illustrated in FIG. 1.

FIG. 4 is a diagram exemplifying the allocation of logical addresses in each platter of the disk device #1 illustrated in FIG. 1.

FIG. 5 is a block diagram illustrating a process of setting a shift amount in the storage system illustrated in FIG. 1.

FIG. 6 is a block diagram illustrating access processing in a case where no error occurs with the disk devices in the storage system illustrated in FIG. 1.

FIG. 7 is a block diagram illustrating access processing in a case where an error occurs with the disk devices in the storage system illustrated in FIG. 1.

FIG. 8 is a flowchart illustrating the process of setting the shift amount in the storage system illustrated in FIG. 1.

FIG. 9 illustrates an example of a Redundant Arrays of Inexpensive Disks (RAID) configuration information table in the storage system illustrated in FIG. 1.

FIG. 10 illustrates an example of a logical block table in the storage system illustrated in FIG. 1.

FIG. 11 is a flowchart illustrating a process of setting logical blocks in a storage system as a related example.

FIG. 12 illustrates an example of a RAID configuration information table in the related example.

### DESCRIPTION OF EMBODIMENT(S)

However, if errors start to occur frequently due to various problems originating from a particular head in each disk device, an error occurs at the same region in the disks. This results in bad data (in other words, partial data loss).

When a failure that has a certain tendency occurs in heads or disk surfaces of the disk devices, accessed are the heads or the disk surfaces with the failure in each of the disks formed as a mirroring pair. Consequently, an error occurs, and recovery via mirroring is impossible.

According to an aspect of the embodiment, provided is a solution to improve the failure tolerance of a storage system.

Hereinafter, an embodiment is described with reference to the drawings. The following embodiment is merely an example and is not intended to exclude the application of various modification examples and techniques not explicitly described in the embodiment. For example, the present embodiment may be variously modified and changed without departing from the gist of the embodiment.

The drawings are not intended to include only constituent elements illustrated in the drawings and may include other functions and the like.

Hereinafter, the same reference signs indicate the same or similar components in the drawings, and duplicate description thereof is omitted.

### [A] EXAMPLE OF EMBODIMENT

### [A-1] Example of System Configuration

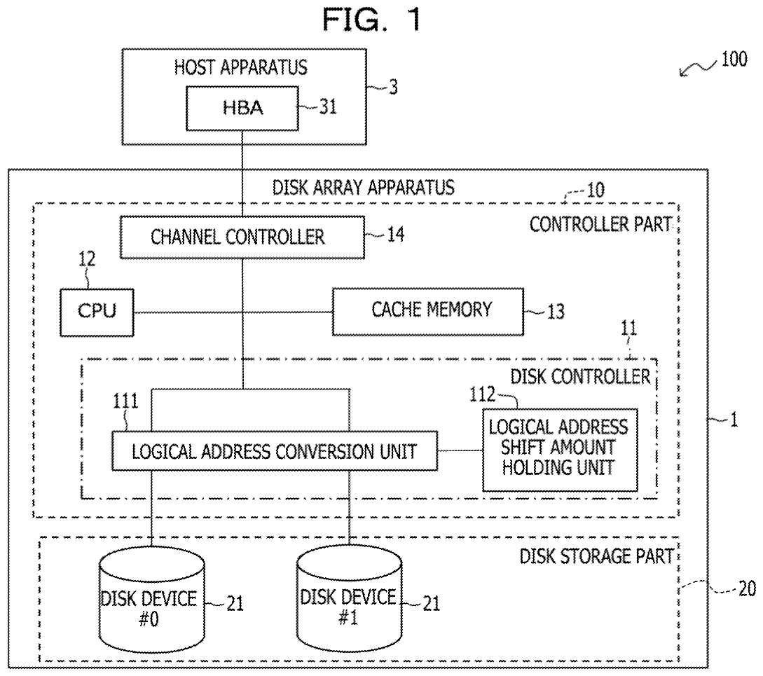

FIG. 1 is a block diagram schematically illustrating a configuration example of a storage system 100 in an example of the embodiment.

The storage system 100 includes a disk array apparatus 1 and a host apparatus 3.

The host apparatus 3 is an example of a higher-level apparatus and includes a host bus adaptor (HBA) 31 as data transfer means.

The HBA 31 requests the disk array apparatus 1 to write data and transfers the data to be written to the disk array apparatus 1. The HBA 31 executes read request to the disk array apparatus 1 and receives the read data from the disk array apparatus 1. The HBA 31 is a card adaptor compatible with a Peripheral Components Interconnect (PCI) bus in a computer, for example.

The disk array apparatus 1 includes a controller part 10 and a disk storage part 20.

The disk storage part 20 includes a plurality of disk devices 21.

The disk devices 21 are an example of storage devices and store data via mirroring, for example. In the illustrated example, one of the disk devices 21 that form a mirroring pair is denoted as a disk device #0 while the other disk device 21 is denoted as a disk device #1. In an example, the disk devices #0 and #1 are magnetic disk devices (in other words, hard disk devices).

Note that the disk storage part 20 may be provided with a plurality of mirroring pairs.

The controller part 10 is an example of a storage control apparatus and controls write of data to the disk storage part 20 and read of data from the disk storage part 20 upon request from the HBA 31. The controller part 10 includes a disk controller 11, a central processing unit (CPU) 12, a cache memory 13, and a channel controller 14.

The channel controller 14 executes data transfer to and from the HBA 31 of the host apparatus 3. The channel controller 14 sends a data write request from the HBA 31 to the CPU 12 and transmits data to be written from the HBA 31 to the cache memory 13. The channel controller 14 sends a data read request from the HBA 31 to the CPU 12 and transmits data read from the cache memory 13 or the disk controller 11 to the HBA 31.

The CPU 12 executes a write request and a read request from the HBA 31. The CPU 12 executes an arithmetic operation for data transfer and executes data transfer between the channel controller 14, the cache memory 13, and the disk controller 11 based on the result of the arithmetic operation.

For example, the CPU 12 processes access to the disk device #0 or #1 from the host apparatus 3.

The CPU 12 controls operation of the entire controller part 10, for example. The device that controls the operation of the entire controller part 10 is not limited to the CPU 12, but may be any one of an MPU, a DSP, an ASIC, a PLD, and an FPGA. The device that controls the operation of the entire controller part 10 may be a combination of two or more of a CPU, an MPU, a DSP, an ASIC, a PLD, and an FPGA. The MPU is an abbreviation for microprocessor unit, the DSP is an abbreviation for digital signal processor, and the ASIC is an abbreviation for application-specific integrated circuit. The PLD is an abbreviation for programmable logic device, and the FPGA is an abbreviation for field-programmable gate array.

The cache memory 13 temporarily stores data when the data is transferred between the channel controller 14 and the disk controller 11.

The disk controller 11 controls read and write of data from and to the disk devices #0 and #1 under control of the CPU 12. A write request and a read request from the HBA 31 contain the logical addresses specifying the block to be read and the block to be written. The disk controller 11 includes a logical address conversion unit 111 and a logical address shift amount holding unit 112.

The logical address shift amount holding unit 112 is an example of a holding unit and holds a shift amount by which to shift logical addresses. A number F of logical blocks in each platter is calculated from disk-specific information read from each disk device 21 by the CPU 12 (for example, the product ID, the capacity, the block size, the total number of blocks, the rotational speed, the number of heads, and the number of cylinders). An integer multiple of the number F of logical blocks is held as a shift amount in the logical address shift amount holding unit 112.

For example, the logical address shift amount holding unit 112 may hold a shift amount for the logical addresses in the storage device #1 relative to the storage device #0. The logical address shift amount holding unit 112 may hold different shift amounts for storage devices #1 to #n (n is a natural number of 2 or more). The logical address shift amount holding unit 112 may hold an integer multiple of the number of logical blocks contained in one surface of a disk 211 included in each of the storage devices #0 and #1 as a shift amount.

The logical address conversion unit 111 is an example of a conversion unit. The logical address conversion unit 111 passes a logical address from the HBA 31 as is to one of the disk devices 21 in the mirroring configuration (for example, the disk device #0). The logical address conversion unit 111 converts the logical address by shifting it by the shift amount held in the logical address shift amount holding unit 112 and passes the converted logical address to the other disk device 21 in the mirroring configuration (for example, the disk device #1).

For example, for access to the same physical position in the storage devices #0 and #1, the logical address conversion unit 111 performs control involving conversion of the same physical position into different logical addresses.

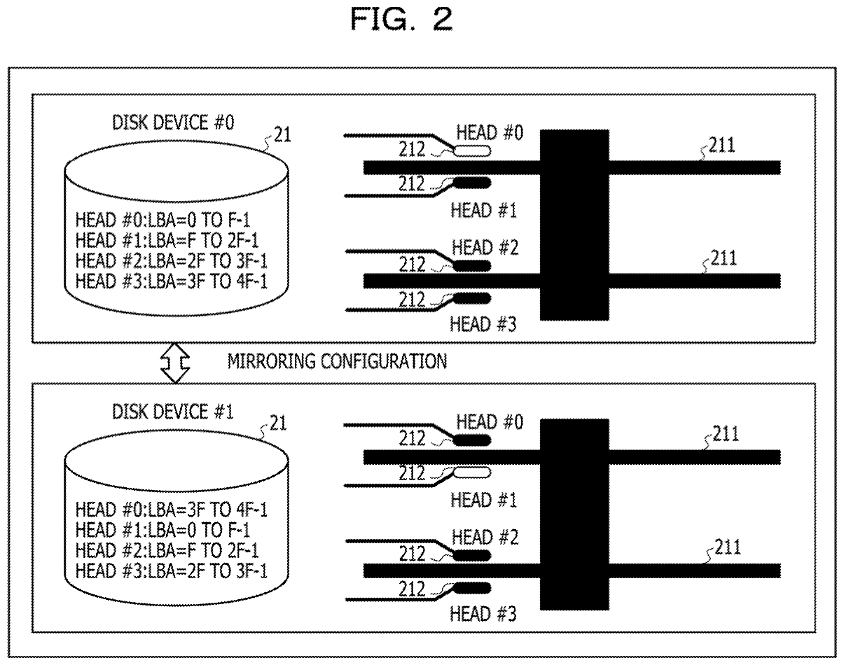

The logical address conversion unit 111 converts a logical address M into MOD(M+G, S). F is the number of logical blocks in one surface of each disk 211 (described later with reference to FIG. 2), and G is the shift amount held in the logical address shift amount holding unit 112, which may be expressed as G=n×F (n is a predetermined integer). M is a logical address to be accessed by the HBA 31, and S is the total number of logical blocks in the disk device 21. MOD represents a modulo operation, and MOD(M+G, S) represents the remainder after division of M+G by S.

For example, the logical address conversion unit 111 may perform the control involving the conversion by setting a logical address M for the storage device #0, converting the logical addresses into MOD(M+G, S), and setting the MOD(M+G, S) for the storage device #1.

FIG. 2 is a diagram exemplifying the positional relationship between heads 212 and the disks 211 in each disk device 21 illustrated in FIG. 1.

In the illustrated example, each disk device 21 includes two disks 211 and four heads 212 for the front surface and back surface of the disks 211. Of the four heads 212, a head #0 is for the front surface (or the upper surface in the figure) of the first (or the upper side in the figure) disk 211, and a head #1 is for the back surface (or the lower surface in the figure) of the first disk 211. Of the four heads 212, a head #2 is for the front surface of the second (or the lower side in the figure) disk 211, and a head #3 is for the back surface of the second disk 211.

In the illustrated example, in the disk device #0, logical addresses 0 to F−1 are allocated to the head #0, logical addresses F to 2F−1 are allocated to the head #1, logical addresses 2F to 3F−1 are allocated to the head #2, and logical addresses 3F to 4F−1 are allocated to the head #3.

In the disk device #1, on the other hand, logical addresses with the shift amount G=F added to them by the logical address conversion unit 111 are allocated. For example, in the disk device #1, logical addresses 3F to 4F−1 are allocated to the head #0, logical addresses 0 to F−1 are allocated to the head #1, logical addresses F to 2F−1 are allocated to the head #2, and logical addresses 2F to 3F−1 are allocated to the head #3.

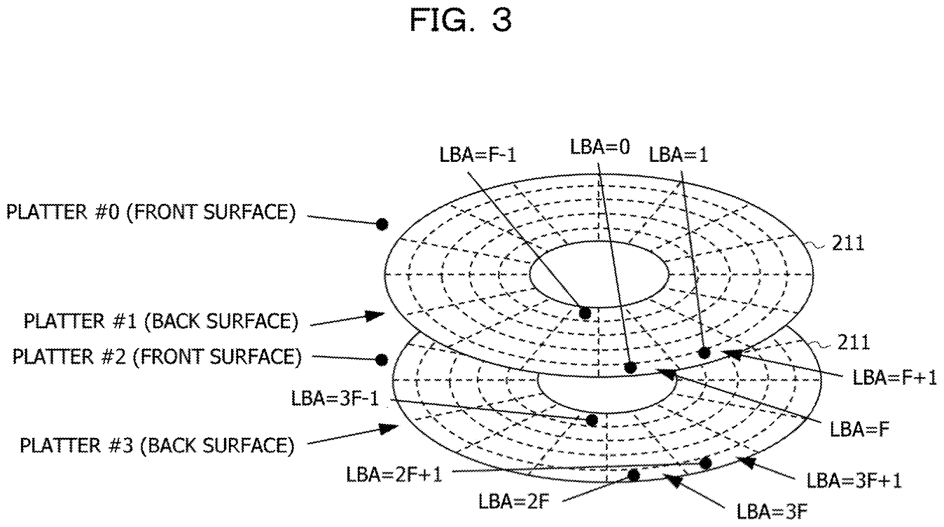

FIG. 3 is a diagram exemplifying the allocation of logical addresses in each platter of the disk device #0 illustrated in FIG. 1.

FIG. 3 illustrates the correspondence between logical addresses in the disk device #0 and physical positions on surfaces of its disks 211.

The front surface (or the upper surface in the figure) of the first (or the upper side in the figure) disk 211 is illustrated as a platter #0, and are allocated the logical addresses 0 to F−1 to be read and written by the head #0. The back surface (or the lower surface in the figure) of the first disk 211 is illustrated as a platter #1, and are allocated the logical addresses F to 2F−1 to be read and written by the head #1. The front surface of the second (or the lower side in the figure) disk 211 is illustrated as a platter #2, and are allocated the logical addresses 2F to 3F−1 to be read and written by the head #2. The back surface of the second disk 211 is illustrated as a platter #3, and are allocated the logical addresses 3F to 4F−1 to be read and written by the head #3.

In each platter, logical addresses are allocated from the outer side toward the inner side along a counterclockwise direction in tracks formed concentrically on the disk 211. The logical address=0 is allocated to the outermost track on the platter #0.

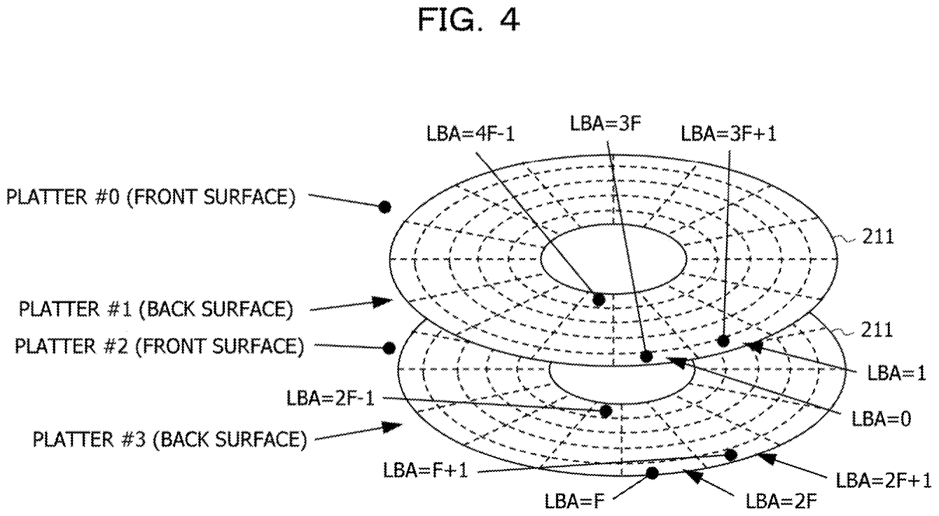

FIG. 4 is a diagram exemplifying the allocation of logical addresses in each platter of the disk device #1 illustrated in FIG. 1.

FIG. 4 illustrates the correspondence between logical addresses in the disk device #1 and physical positions on surfaces of its disks 211.

The front surface (or the upper surface) of the first (the upper side in the figure) disk 211 is illustrated as a platter #0, and are allocated the logical addresses 3F to 4F−1 to be read and written by the head #0. The back surface (or the lower surface) of the first disk 211 is illustrated as a platter #1, and are allocated the logical addresses 0 to F−1 to be read and written by the head #1. The front surface of the second (the lower side in the figure) disk 211 is illustrated as a platter #2, and are allocated the logical addresses F to 2F−1 to be read and written by the head #2. The back surface of the second disk 211 is illustrated as a platter #3, and are allocated the logical addresses 2F to 3F−1 to be read and written by the head #3.

In each platter, logical addresses are allocated from the outer side toward the inner side along a counterclockwise direction in tracks formed concentrically on the disk 211. The logical address=0 is allocated to the outermost track on the platter #1.

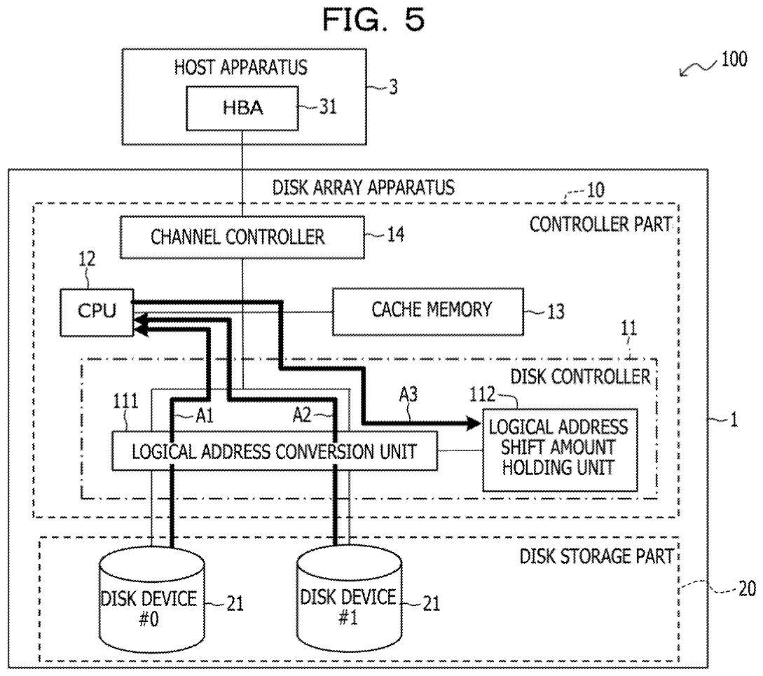

FIG. 5 is a block diagram illustrating a process of setting the shift amount in the storage system 100 illustrated in FIG. 1.

The CPU 12 reads disk-specific information (for example, the product ID, the capacity, the block size, the total number of blocks, the rotational speed, the number of heads, and the number of cylinders) from each of the disk devices #0 and #1 (see reference signs A1 and A2).

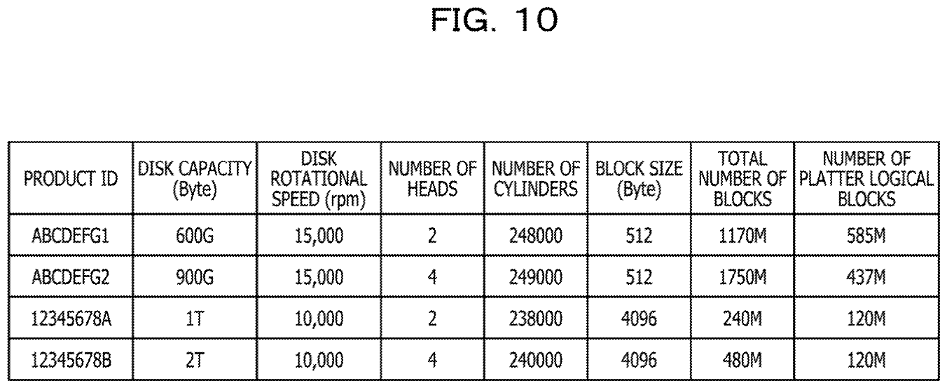

The CPU 12 refers to a logical block table to be described later with reference to FIG. 10 to figure out the number F of logical blocks in each platter, and sets the number F of logical blocks or an integer multiple of F as the shift amount G for logical addresses in the logical address shift amount holding unit 112 (see reference sign A3).

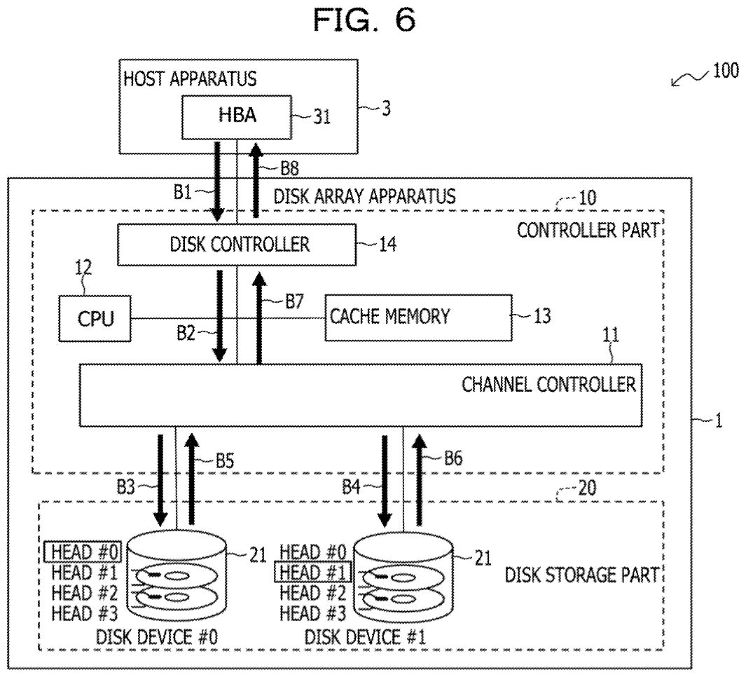

FIG. 6 is a block diagram illustrating access processing in a case where no error occurs with the disk devices 21 in the storage system 100 illustrated in FIG. 1.

The HBA 31 sends a data read request to the channel controller 14 (see reference sign 81).

The channel controller 14 sends the data read request from the HBA 31 to the CPU 12, and the CPU 12 controls the controller part 10 to send the read request from the HBA 31 to the disk controller 11 (see reference sign B2).

Under control of the CPU 12, the disk controller 11 passes a logical address designated by the HBA 31 to the disk device #0 and controls data read (see reference sign 63).

To the disk device #1, on the other hand, the disk controller 11 passes a converted logical address and controls data read (see reference sign 14). The converted logical address is a logical address shifted by the addresses in one surface of a disk 211 mentioned above with reference to FIG. 2. By this conversion, the logical addresses 0 to F−1, for example, are read by the head #0 in the disk device #0 but are read by the head #1 in the disk device #1.

The disk controller 11 performs an error check on and compares the pieces of data read from the disk devices #0 and #1 (see reference signs B5 and 86).

When the pieces of data match, the disk controller 11 sends the piece of data from a predetermined one of the disk devices 21 to the channel controller 14 (see reference sign 17).

The channel controller 14 sends the data to the HBA 31 (see reference sign 88), and the access processing in the case where no error occurs with the disk devices 21 ends.

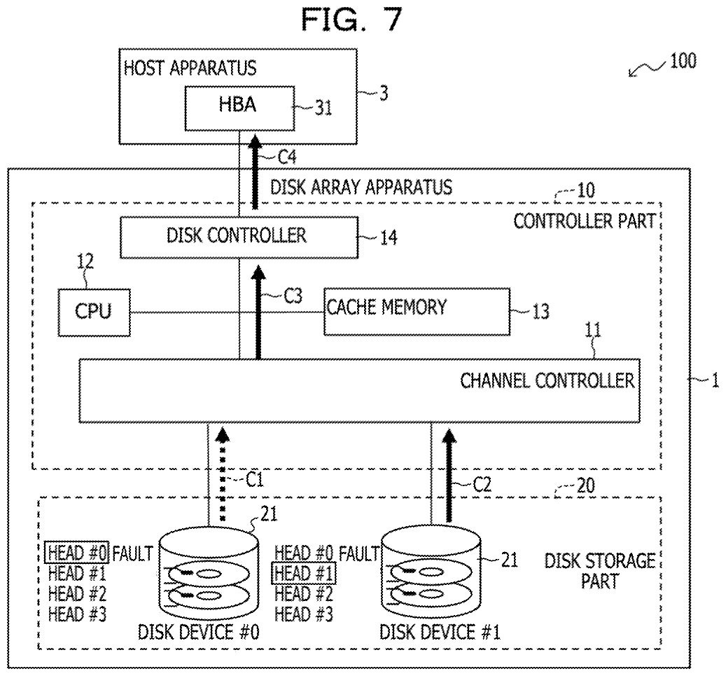

FIG. 7 is a block diagram illustrating access processing in a case where an error occurs with the disk devices 21 in the storage system 100 illustrated in FIG. 1.

When an error is detected from one of the pieces of data read from the disk devices #0 and #1, the disk controller 11 sends the properly read piece of data to the channel controller 14. When an error is detected from both pieces of data read from the disk devices #0 and #1 or when the pieces of data do not match, the disk controller 11 issues an error notification (or bad data) to the HBA 31 through the channel controller 14. For example, a RAID-1 mirroring operation is performed in the storage system 100.

There are cases where a design or manufacturing problem originating from a particular one of the heads 212 causes an operation failure of the heads #0 in both disk devices #0 and #1. In such a case, a read request for the logical address 0 to F−1 in the disk device #0 ends up with a read error since the logical addresses are allocated to the head #0 (see reference sign C1). However, for a read request for the logical addresses 0 to F−1 in the disk device #1, the data is properly read since the logical addresses are allocated to the head #1 (see reference sign C2).

The disk controller 11 sends the data to the HBA 31 through the channel controller 14 (see reference signs C3 and C4), and the access processing in the case where an error occurs ends.

Consider a case where the disk devices #0 and #1 have the same allocation of logical addresses, and a design or manufacturing problem originating from a particular one of the heads 212 causes an operation failure of the heads #0 in both disk devices #0 and #1. In this case, since the logical addresses 0 to F−1 are allocated to the heads #0 in both disk devices #0 and #1, a read request for the logical addresses 0 to F−1 ends up with abnormal read or an error notification, and the disk controller 11 is notified of it and determines that the read result is bad data. The disk controller 11 then issues the error notification to the HBA 31 through the channel controller 14.

Note that in the case of a storage system 100 including a plurality of data disks and a single parity disk like RAID 4, each data disk and the parity disk may be controlled to have the same logical address allocated to different heads 212.

In the case of a storage system 100 configured to have parity distributed to each disk like RAID 5, all disk devices 21 may be controlled to have the same logical address allocated to different heads 212.

### [A-2] Operation Example

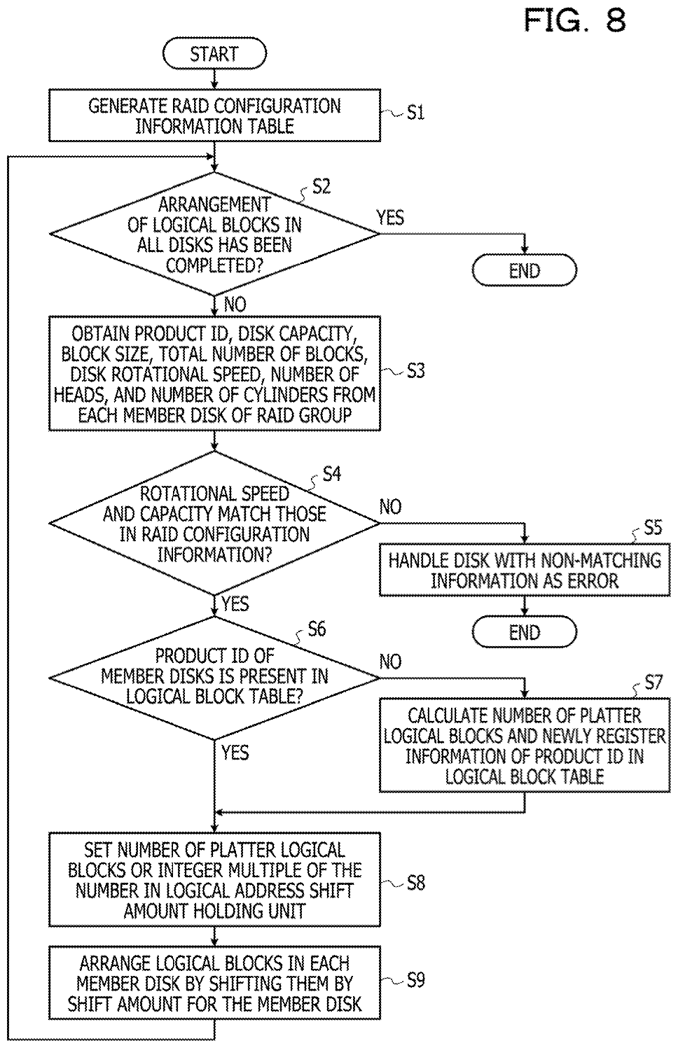

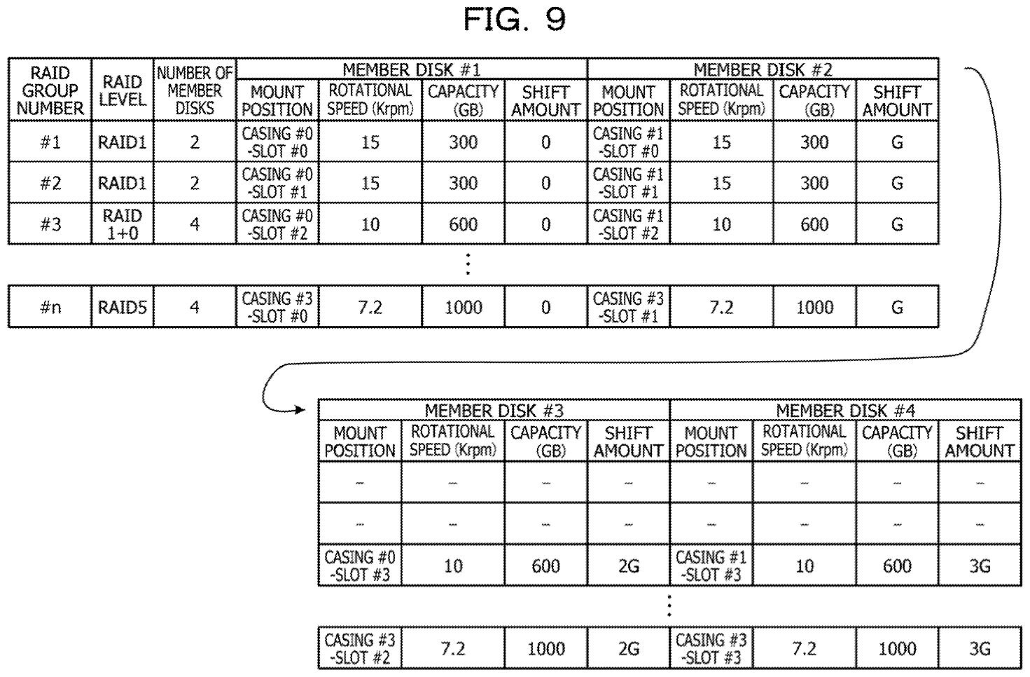

The process of setting the shift amount in the storage system 100 illustrated in FIG. 1 will be described by following a flowchart illustrated in FIG. 8 (steps S1 to S9) with reference to FIGS. 9 and 10. FIG. 9 illustrates an example of a RAID configuration information table in the storage system 100 illustrated in FIG. 1. FIG. 10 illustrates an example of the logical block table in the storage system 100 illustrated in FIG. 1.

The controller part 10 generates a RAID configuration information table as illustrated in FIG. 9 in accordance with an operation by the administrator of the disk array apparatus 1 (step S1).

As illustrated in FIG. 9, in the RAID configuration information table, a record is generated on a RAID group basis. The record of each RAID group contains a RAID group number, a RAID level, the number of member disks, and information on each member disk. The information on each member disk includes, for example, the mount position, rotational speed, and capacity of the member disk and also its shift amount held in the logical address shift amount holding unit 112.

The controller part 10 determines whether the arrangement of logical blocks in all disk devices 21 has been completed (step S2).

If the arrangement of logical blocks in all disk devices 21 has been completed (see the Yes route at step S2), the shift amount setting process ends.

On the other hand, if there are disk devices 21 whose logical blocks are yet to be arranged (see the No route at step S2), the process proceeds to step S3. The controller part 10 obtains, for example, the product ID, the disk capacity, the disk rotational speed, the number of heads, the number of cylinders, the block size, and the total number of blocks from each member disk in the RAID group (step S3).

The product ID is a device identification number of the disk device 21, and may be obtained from response data of an Inquiry command. The disk capacity is the capacity of the disk device 21, and may be obtained from response data of a Read Capacity command. The disk rotational speed is the number of revolutions per unit time of the disks 211 mounted in the disk device 21, and may be obtained from response data of a Mode Sense command. The number of heads is the number of heads 212 mounted in the disk device 21, and may be obtained from the response data of the Mode Sense command. The number of cylinders is the number of sets of tracks in the disks 211 of the disk device 21, and may be obtained from the response data of the Mode Sense command. The block size is the size of each block in the disk device 21, and may be obtained from the response data of the Read Capacity command. The total number of blocks is the total number of blocks contained in the disk device 21, and may be obtained from the response data of the Read Capacity command.

Each piece of information thus obtained is registered in a logical block table as illustrated in FIG. 10. As illustrated in FIG. 10, the logical block table contains, for example, product IDs, disk capacities, disk rotational speeds, the numbers of heads, the numbers of cylinders, block sizes, the total numbers of blocks, and the numbers of platter logical blocks.

The controller part 10 determines whether the disk capacity and the disk rotational speed obtained from each disk device 21 match the capacity and the rotational speed contained in the RAID configuration information table (step S4).

If at least the capacities or the rotational speeds do not match (see the No route at step S4), the controller part 10 handles the disk device 21 with the non-matching information as an error (step S5). The shift amount setting process then ends.

On the other hand, if the capacities and the rotational speeds match (see the Yes route at step S4), the controller part 10 determines whether the product ID of the member disks in the RAID group is present in the logical block table (step S6).

If the product ID is not present in the logical block table (see the No route at step S6), the process proceeds to step S7. The controller part 10 calculates the number of logical blocks in each platter from the information obtained in step S3 and newly registers the information of the product ID in the logical block table (step S7), and the process proceeds to step S8.

On the other hand, if the product ID is present in the logical block table (see the Yes route at step S6), the process proceeds to step S8. The controller part 10 obtains the number of logical blocks in each platter from the product ID in the logical block table, and sets this number of logical blocks or an integer multiple of the number in the logical address shift amount holding unit 112 of the RAID configuration information table (step S8).

The controller part 10 arranges the logical blocks in each member disk by shifting the logical addresses by the shift amount for the member disk (step S9). The process then returns to step S2.

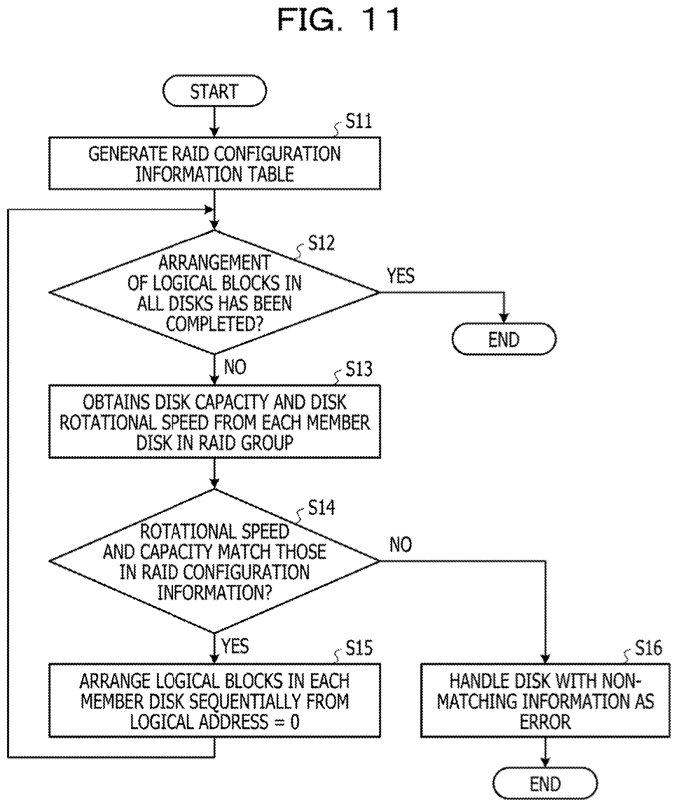

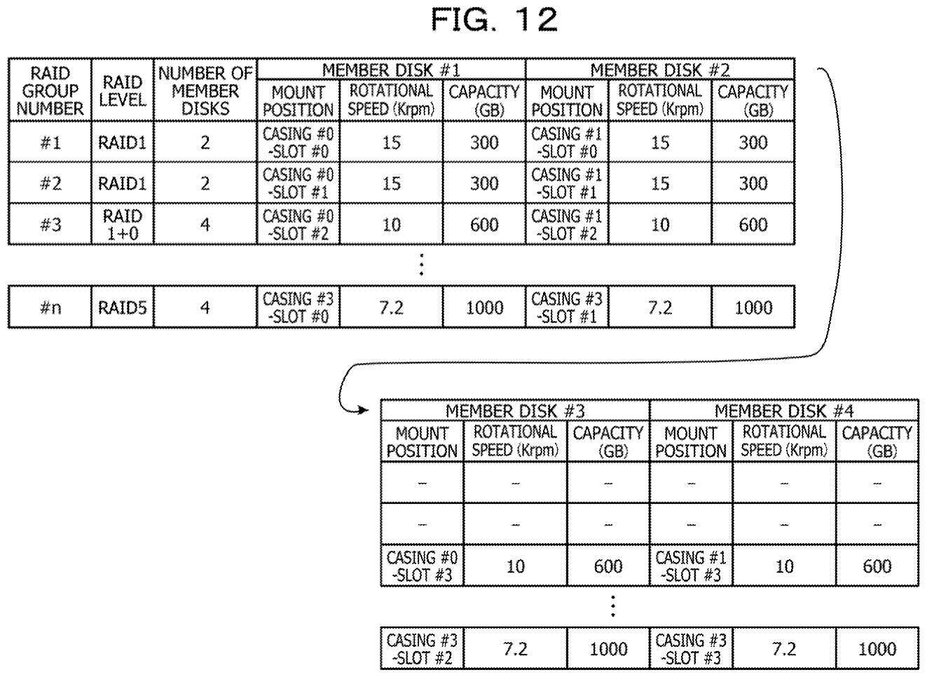

Next, a process of setting the arrangement of logical blocks in a storage system as a related example will be described by following a flowchart illustrated in FIG. 11 (steps S11 to S16) with reference to FIG. 12.

The controller part generates a RAID configuration information table as illustrated in FIG. 12 in accordance with an operation by the administrator of the disk array apparatus (step S11).

As illustrated in FIG. 12, in the RAID configuration information table, a record is generated on a RAID group basis. The record of each RAID group contains a RAID group number, a RAID level, the number of member disks, and information on each member disk. The information on each member disk includes, for example, the mount position, rotational speed, and capacity of the member disk. Thus, unlike the RAID configuration information table in the example of the embodiment illustrated in FIG. 9, the RAID configuration information table in the related example does not contain each member disk's shift amount.

The controller part determines whether the arrangement of logical blocks in all disk devices has been completed (step S12).

If the arrangement of logical blocks in all disk devices has been completed (see the Yes route at step S12), the shift amount setting process ends.

On the other hand, if there are disk devices whose logical blocks are yet to be arranged (see the No route at step S12), the controller part obtains, for example, the disk capacity and the disk rotational speed from each member disk in the RAID group (step S13).

The disk capacity is the capacity of the disk device, and may be obtained from response data of a Read Capacity command. The disk rotational speed is the number of revolutions per unit time of the disks mounted in the disk device, and may be obtained from response data of a Mode Sense command.

The controller part determines whether the disk capacity and the disk rotational speed obtained from each disk device match the capacity and the rotational speed contained in the RAID configuration information table (step S14).

If the capacities and the rotational speeds match (see the Yes route at step S14), the controller part arranges logical blocks in the member disk sequentially from the logical address=0 (step S15). The process then returns to step S12.

On the other hand, if at least the capacities or the rotational speeds do not match (see the No route at step S14), the controller part handles the disk device with the non-matching information as an error (step S16). The shift amount setting process then ends.

Thus, in the related example, unlike the above-described example of the embodiment, logical blocks are sequentially arranged from the logical address=0 in all member disks. In case of a fault such as a failure of the same head in each member disk, there is a possibility of failing to read data.

### [A-3] Effects

With the storage control apparatus and the storage control program described above, the following advantageous effects may be achieved, for example.

The CPU 12 processes access to the disk device #0 or #1 from the host apparatus 3. For access to the same physical position in the storage devices #0 and #1, the logical address conversion unit 111 performs the control involving conversion of the same physical position into different logical addresses.

In this manner, even when an error occurs due to a failure of one of the disk devices 21, for example, the disk devices #0 and #1, in the storage system 100, data may be read from the other disk device 21.

The logical address shift amount holding unit 112 holds a shift amount for the logical addresses in the storage device #1 relative to the storage device #0.

This may enable efficient conversion of the logical addresses.

The logical address shift amount holding unit 112 holds different shift amounts for the storage devices #1 to #n.

This may improve the failure tolerance of even a storage system 100 with a RAID group including three or more disk devices 21.

The logical address shift amount holding unit 112 holds an integer multiple of the number of logical blocks included in one surface of a disk 211 included in each of the storage devices #0 and #1 as the shift amount.

The storage devices #0 and #1 have the same number S of logical blocks, the number of logical blocks in one surface of a disk 211 is F, the predetermined integer n is given, the shift amount is G=n×F, and the modulo operation MOD is given. In this case, the logical address conversion unit 111 performs the control involving the conversion by setting a logical address M for the storage device #0, converting the logical addresses into MOD(M+G, S), and setting the MOD(M+G, S) for the storage device #1.

With the above, even when a head 212 in each of the plurality of disk devices 21 for a surface of the same disk 211 is prone to experience a failure, data to be mirrored may be recorded in surfaces of disks 211 that use different heads 212. This may improve the failure tolerance.

### [B] OTHERS

The techniques disclosed herein are not limited to the foregoing embodiment and may be variously modified and changed without departing from the gist of the embodiment. Each of the configurations described in the embodiment and each of the processes described in the embodiment may be selected. Alternatively, two or more of the configurations described in the embodiment may be combined, and two or more of the processes described in the embodiment may be combined.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A storage control apparatus configured to be coupled to a redundant configuration including a first and second storage devices, the storage control apparatus comprising:
a memory; and
processing circuitry coupled to the memory, the processing circuitry being configured to
execute a first processing that includes dealing with access to any of the first and second storage devices from a higher-level apparatus; and
execute a second processing that includes converting an access destination of the access such that each same physical position in the first and second storage devices corresponds to a first logical address for a first storage device and a second logical address for the second storage device, the first logical address being a logical address different from the second logical address.

2. The storage control apparatus according to claim 1,
wherein the memory is configured to store a shift amount for a logical address in the second storage device relative to the first storage device,
wherein the converting of the access destination is configured to obtain the second logical address by shifting a third logical address by the shift amount stored in the memory, the third logical address being a logical address indicated by the access from the higher-level apparatus.

3. The storage control apparatus according to claim 2,
wherein the memory is configured to store a plurality of the shift amounts differing from each other for a plurality of the second storage devices, respectively.

4. The storage control apparatus according to claim 2,
wherein the memory is configured to store an integer multiple of the number of logical blocks contained in one surface of a magnetic disk included in each of the first and second storage devices as the shift amount.

5. The storage control apparatus according to claim 2, wherein when the first and second storage devices have a same number S of logical blocks, the number of logical blocks in one surface of a magnetic disk is F, a predetermined integer n is given, the shift amount is G=n×F, and a modulo operation MOD is given,
the converting of the access destination is configured to
set a logical address M as the first logical address for the first storage device,
convert the logical address M into MOD(M+G, S), and
set the MOD(M+G, S) as the second logical address for the second storage device.

6. A non-transitory computer-readable storage medium for storing a storage control program configured to cause a computer to execute processing, the computer being configured to be coupled to a redundant configuration including a first and second storage devices, the processing comprising:
executing a first processing that includes dealing with access to any of the first and second storage devices from a higher-level apparatus; and
executing a second processing that includes converting an access destination of the access such that each same physical position in the first and second storage devices corresponds to a first logical address for a first storage device and a second logical address for the second storage device, the first logical address being a logical address different from the second logical address.

7. The non-transitory computer-readable storage medium according to claim 6,
wherein the memory is configured to store a shift amount for a logical address in the second storage device relative to the first storage device,
wherein the converting of the access destination is configured to obtain the second logical address by shifting a third logical address by the shift amount stored in the memory, the third logical address being a logical address indicated by the access from the higher-level apparatus.

8. The non-transitory computer-readable storage medium according to claim 7,
wherein the memory is configured to store a plurality of the shift amounts differing from each other for a plurality of the second storage devices, respectively.

9. The non-transitory computer-readable storage medium according to claim 7,
wherein the memory is configured to store an integer multiple of the number of logical blocks contained in one surface of a magnetic disk included in each of the first and second storage devices as the shift amount.

10. The non-transitory computer-readable storage medium according to claim 7,
wherein when the first and second storage devices have a same number S of logical blocks, the number of logical blocks in one surface of a magnetic disk is F, a predetermined integer n is given, the shift amount is G=n×F, and a modulo operation MOD is given,
the converting of the access destination is configured to
set a logical address M as the first logical address for the first storage device,
convert the logical address M into MOD(M+G, S), and
set the MOD(M+G, S) as the second logical address for the second storage device.
